(19) United States
(12) Patent Application Publication
(10) Pub. No.: US 2021/0154813 A1
(43) Pub. Date: May 27, 2021

(54) ADJUSTABLE SEAL PULLER FOR SPINDLE AXLE

(71) Applicant: Tristan Cole Van Sluys, Fort Macleod (CA)

(72) Inventor: Tristan Cole Van Sluys, Fort Macleod (CA)

(21) Appl. No.: 16/697,333

(22) Filed: Nov. 27, 2019

(51) Int. Cl. B25B 27/00

(52) U.S. Cl. CPC B25B 27/0028

(57) ABSTRACT

The present invention relates to a device for removing a variety of seals from wheel axles. The device is specifically designed to be adjustable such that it can fit and function in a number of different applications. The device is particularly designed to remove the second part of a two piece wheel seal from a spindle type axle. The device provides a fast, simple and easy way to perform this task. It is also compact and portable.

### FIELD OF THE INVENTION

The present disclosure relates to a tool for removal of a wheel seal and more particularly to an adjustable wheel seal puller, in particular a wheel seal puller that is specifically designed to remove the second part of a two piece wheel seal from a spindle type axle.

### BACKGROUND

U.S. Pat. No. 3,257,716A—discloses a seal removing device for extracting the seals carried by the housing of a motor vehicle of a transmission. The device comprises an extracting rod having a downwardly extending seal engaging extension or hook portion at an end thereof. The lever carries a shaft engaging spindle or spur which forms, with the end of the shaft, a fulcrum for the lever. The spindle or spur is adjustable in a longitudinal slot in the lever to enable the device to be utilized in removing seals from transmissions having shafts of different diameters. The adjustability of the spur effectively enables the device of the present invention to be utilized most efficiently in removing seals from transmission housings having shafts of different diameters, however it is not particularly well suited for pulling off the second part or flange seal of a wheel seal.

U.S. Pat. No. 6,880,217B2—discloses a seal puller tool head and a hook lever for manipulating the hook in tight clearances. A fulcrum also engages the lever in variable positions. The tool relates to metalworking and to a puller or pusher having a lever operator. The invention relates to a means to assemble or disassemble. The invention discloses a means to apply or remove a resilient article, such as a tube, sleeve, or shaft oil seal. A seal-engaging hook is located on the distal end of the shank, a seal puller tool is adapted for entering an interface between a shaft seal and a sealed shaft to pull the seal. Again the seal puller of this invention is designed for removing the inner bearing cup from a spindle axle and is not particularly well suited for pulling off the flange seal of a wheel seal.

U.S. Pat. No. 7,039,993B1—discloses a tool for pulling or removing seals includes an elongate handle having a manual engagement end and a seal hook member attachment end with a seal hook member pivotally attached to the seal hook member attachment end. The seal hook member includes at least one hook element and a mechanism for pivotally adjusting and fixing the pivotal relationship of the seal hook member with the elongate handle member. The tool is particularly well suited for removing seals situated on the inner surface of a spindle axle.

U.S. Pat. No. 5,617,621A—discloses a tool for removing seals from wheel hubs. The tool comprises a handle or lever portion having an upstanding hook portion and a cross member in connection with the hook portion. The hook portion is perpendicular to the plane of the cross member and the bottom of the hook portion is about flush with the front edge of the cross member. The front of the tool is placed in the bore of the wheel hub and flush against the seal. The tapered ends of the cross member will be aligned against the seal and will hold the hook portion in place when the lever is pivoted. This particular orientation of the components of the tool results in minimal leverage forces.

GB2387806B—discloses a tool for withdrawing retainers for sealing gaskets, The front area of the tool is extended adopting the shape of a virtually rectangular trapezium, the area of which shows an upwards slope with an angle of 160 with reference to the plane of the body. Such area ends in a mouth much larger than the body. Again this particular orientation of the components of the tool results in minimal leverage forces.

U.S. Pat. No. 8,925,165B2—discloses an oil seal removing tool having a pivotable hooking element and a location portion. The location portion has a slidable structure and an elastic element pressing against the slidable structure. The slidable structure is able to be engaged to the hooking element, and the elastic element pushes the slidable structure toward the hooking element. Moving the slidable structure can fix or release the engagement between the slidable structure and the hooking element. This tool is particularly concerned with removal of the first part of a two-piece seal, also the orientation of the components of the tool results in minimal leverage forces.

U.S. Pat. No. 4,211,446A—discloses tool for pulling and removing annular or ring-shaped seals from an automobile transmission housing or the like he pivotal member has a first end which includes a hook structure and is mounted for pivotal movement he main section to allow engagement of the hook structure with the seal and a second position substantially in line with the main section to allow the hook structure to encompass or wrap around the seal and firmly and securely engage the seal. The operation of the seal pulling tool is primarily directed to the removing of a ring-shaped seal from an automobile transmission housing.

US20110147683A1—discloses a puller with an adjustable hook head. The primary object of the invention is to provide a puller with an adjustable hook head that is capable of adjusting the hook head to a desired angle quickly.

U.S. Pat. No. 6,397,447B1—discloses a puller tool used with a pry bar, the pry bar includes a long portion to provide leverage in a curved area, The puller tool is an elongate structure including a hook in a first area. To use the combination to remove a seal about a shaft, the hook of the puller is slipped in-between the shaft and seal to engage the seal back side The pry bar is then moved in a direction to move the bar tip outward away from the seal, pushing against the pry base to push and move the entire puller tool and pull the seal from its seat.

U.S. Pat. No. 5,406,683A—discloses a tool that removes hub seals from wheel hubs. The tool comprises a blade having a generally flat surface, a generally tapered surface, a flat side, a tip side, and a handle attached to the blade. The flat edge is connected to the tip edge to form a corner, which is suitable for insertion into an annular space between the hub seal and bearings on the hub. In order to remove the hub seal, the blade is inserted into the annular space, force is applied to the handle, and leverage is used to remove the hub seal.

The present invention relates to a tool specifically adapted for the heavy duty mechanical and truck mechanical industry. The tool is specifically designed to remove the seals from spindle axles. These seals can be very difficult to remove due to rust and corrosion or the way it was previously installed either with silicone or installed dry. The conventional ways to remove wheel seals, as described in the documents cited above, often relate to removal of the first part of a two-part seal. The typical way the second part of a two-part seal is removed is with a hammer taping on the backside which usually folds over and destroys the seal, which makes it even harder to remove. An alternative method is to use a pry-bar, by prying either off of the ABS sensor which often bends it, or by prying off of the brake shoes which move and don't provide a proper prying surface. Using a zip disc to cut the seal which risks the chance of damaging the spindles seal surface which will cause leaks upon installation of new seal.

None of the above cited documents, either alone or in combination, satisfy the need for a tool that provides a fast, simple and easy way to perform this task. Hence, there remains a need for a tool that will remove wheel seals, specifically flange seals from spindle type wheel axles.

All documents are hereby incorporated by reference.

### BRIEF SUMMARY

It is an object of the invention to provide an adjustable seal puller for a spindle axle.

In accordance with an aspect of the invention there is provided a device for removing a seal from a spindle wheel axle, said device comprising: a hooked member having a shaft with a hook at one end, said shaft further having an adjusting means; a levering member having a first end and a second end, said levering member having a shaft positioned between the first and second ends, said shaft further having an adjusting means; a connecting means adapted to connect the adjusting means on the hooked member to the adjusting means on the levering member, wherein when the hook is engaged with the seal, and the second end of the levering member is positioned as a fulcrum on the spindle, a force can be applied to the first end of the levering member to remove the seal.

In accordance with another aspect of the invention there is provided a method of using the device of the present invention, for removing a seal from a spindle wheel, said method comprising the steps: connecting the hooked member to the levering member, via the adjusting means on the hooked member and the adjusting means on the levering member, using the connecting means; engaging the hook, on the hooked member, with the seal to be removed; positioning the second end of the levering member on the spindle to form a fulcrum; and applying a force to the first end of the levering member such that the seal is removed.
In summary, devices of the present invention relate to tools that are simple to use, that make the job of removing the second piece of a wheel seal quicker to remove. They are cheap to make and are adjustable to fit many different applications.

The advantages and features of the present invention will become better understood with reference to the following more detailed description and claims taken in conjunction with the accompanying drawings in which like elements are identified with like symbols.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates the general device in accordance with one embodiment of the invention.

FIG. 2 illustrates a top view of a device in accordance with an embodiment of the invention.

FIG. 3 illustrates a side view of a device in position on a spindle type wheel axle in accordance with an embodiment of the invention.

FIG. 4 illustrates a perspective side view of a device in accordance with one embodiment of the invention.

FIG. 5 illustrates a rotated perspective side view of a device in accordance with one embodiment of the invention.

FIG. 6 illustrates a side and cross sectional view of a device in accordance with an embodiment of the invention.

### DETAILED DESCRIPTION

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

The present invention describes a device or tool that is specifically designed to remove the second piece of a two-part wheel seal from the spindle on a big tuck or trailer. A big truck or trailer axle has a machined section on both ends which is the “spindle” where the hub is mounted, and the wheels bolt to the hub. The hub is mounted with the wheel bearings inside, so the back of the hub needs a seal between itself and the spindle to keep oil in to lubricate the bearings).

When the hub is required to be pulled off for any number of reasons, the two-piece wheel seal splits apart, and leaves behind a flange seal section. Various embodiments of the tool of the present invention are designed to make the removal of the flange seal of the two-piece wheel seal simple, easy and fast. The tool uses a lever action which fulcrums on the end of the spindle and with the use of a pin, pulls a hooked shaft which is hooked behind the seal. Both the lever and the shaft have multiple holes for adjustability in multiple applications. The hook is designed to pull right on the bottom section of the seal, i.e. the mating surface to the spindle. The lever has a section cut out so the shaft can pass through for ultimate strength.

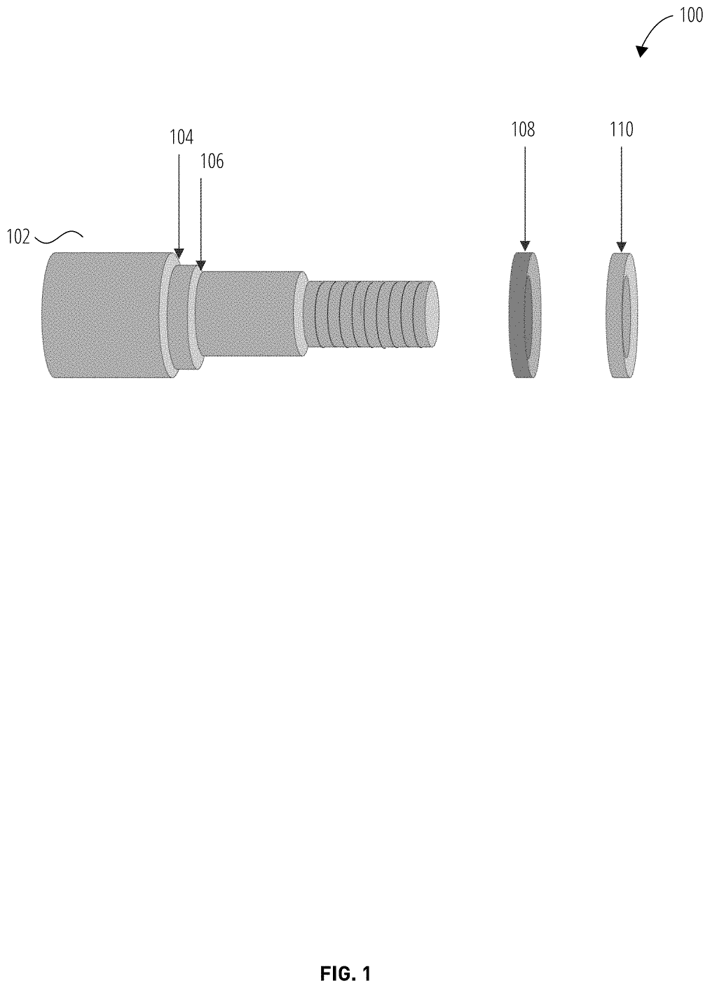

FIG. 1 is an exploded view 100 of a typical spindle type wheel axle 102.

After removal of the wheel hub both parts of a two-piece wheel seal may remain on the spindle. The two-piece wheel seal comprises a first part of 2-piece wheel seal 110 and a second part of 2-piece wheel seal 108.

Often the first part of 2-piece wheel seal 110, which is attached to the seating for first part of 2-piece wheel seal 106, is removed with the wheel hub. The second part of 2-piece wheel seal 108, which is attached to the seating for first part of 2-piece wheel seal 106, remains in place when the hub is removed.

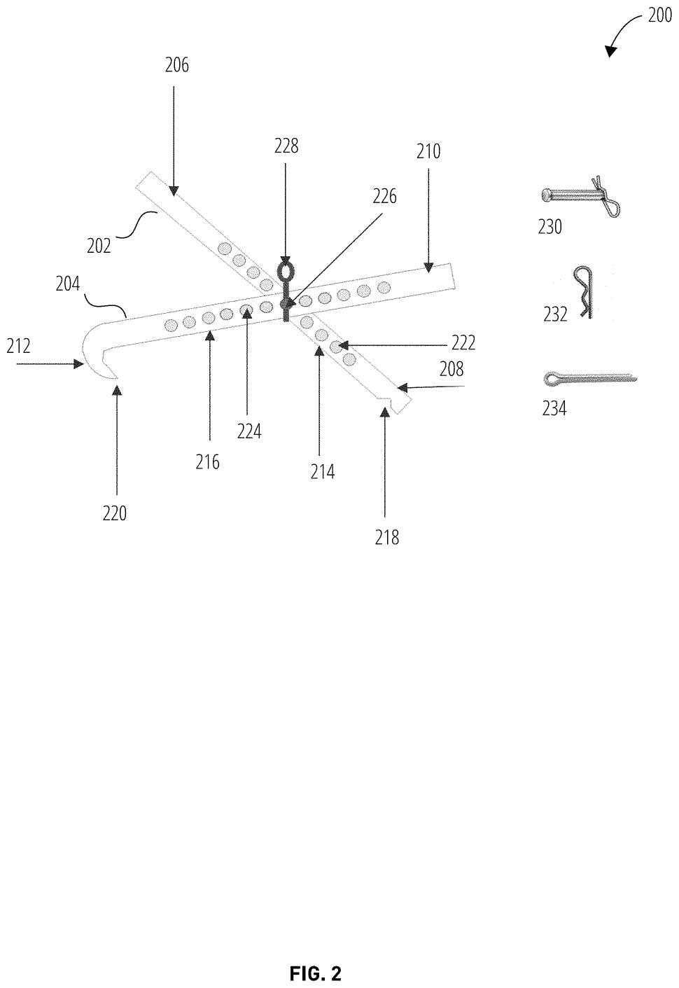

FIG. 2 illustrates an embodiment of an adjustable wheel seal puller in accordance with an embodiment of the invention.

The wheel seal puller tool comprises a notched member 202 and a hooked member 204. The notched member 202 has a first end of notched member 206 and a second end of notched member 208, the first and second ends being separated by a shaft of the notched member 214. The shaft of the notched member 214 has a means of adjustment of notched member 222. The first end of notched member 206 functions as a handle. The second end of notched member 208 comprises a notch 218

The hooked member 204 has a first end of hooked member 210 and a second end of hooked member 212, the first and second ends being separated by a shaft of hooked member 216. The shaft of hooked member 216 has a means of adjustment of hooked member 224. The second end of hooked member 212 comprises a hook 220. The hook 220 could be shaped in any different way to accommodate many different applications.

The notched member 202 and hooked member 204 may be connected together by a connection means 226. Various different means of connection are contemplated in different embodiments of the invention. For example, a clevis pin 230 can be inserted into the means of adjustment of notched member 222 and means of adjustment of hooked member 224 and secured in place by a straight or spring pin 232 or cotter pin 234. The shaft of hooked member 216 can be fastened to one side or the other of the notched member 202 via connection means 226.

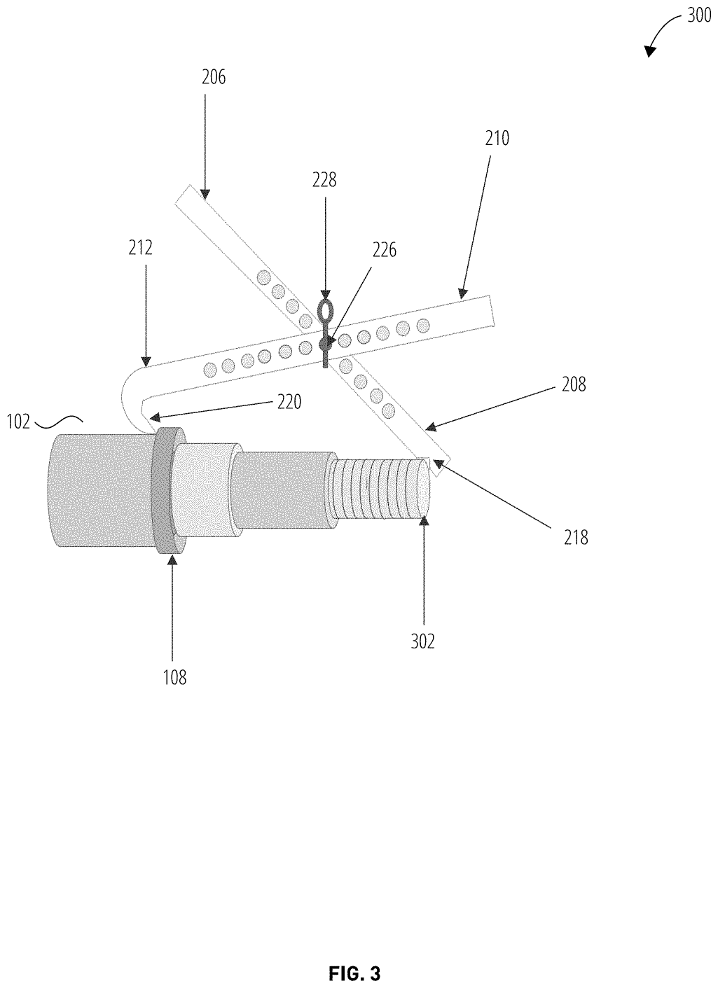

FIG. 3 illustrates a typical working example of an embodiment of an adjustable wheel seal puller in accordance with an embodiment of the invention.

The hook 220 on the second end of hooked member 212 is engaged behind the second part of 2-piece wheel seal 108. The notch 218 on the second end of notched member 208 is lined up with the end of spindle 302. The hooked member 204 and notched member 202 are adjusted into an appropriate position to provide a levering motion. The means of adjustment of notched member 222 and the means of adjustment of hooked member 224 are then connected using a pin 228.

In accordance with a method of the invention there is provided the use of the tool disclosed herein. In use, the mechanic would line up the means of adjustment of hooked member 224 with the means of adjustment of notched member 222 with second part of 2-piece wheel seal 108 and the end of spindle 302 respectively. The means of connection, typically a clevis pin 230 and some form of straight or spring pin 232, are used to connect shaft of the notched member 214 to the shaft of hooked member 216 at an appropriate position. The mechanic would then engage the hook 220 with second part of 2-piece wheel seal 108 and engage the notch 218 with the end of spindle 302. Subsequent pulling force is then applied to the first end of notched member 206. The resulting lever action, which fulcrums on the end of the spindle, pries the second part of 2-piece wheel seal 108 from the seating for second part of 2-piece wheel seal 104. Both shaft of hooked member 216 and the shaft of the notched member 214 have multiple holes for adjustability leading to multiple applications.

In circumstances where the first part of 2-piece wheel seal 110 remains in place after removal of the wheel hub, the device may be used in a similar manner to remove the first part of 2-piece wheel seal 110.

A worker skilled in the art would understand that various different uses for different embodiments of the tool or device are possible. For example, it is contemplated that the tool or device could be used to pull wheel bearings off of spindles or out of hubs on big trucks or lighter duty trucks.

The tool could be used to pull hubs off of big trucks/trailers and possibly light duty vehicles.

Additionally, the tool could be used to pull gears off engines or transmissions

Similarly, the tool could pull axle seals off automotive or medium duty vehicles.

Moreover, a small version could be used for many different applications on motorcycles or any other small engine vehicles.

Other uses include, but are not limited to: pulling any sort of seals, bearings, sleeves, gears, caps, or anything that needs a pulling force to be removed on any types of vehicles or even other applications.

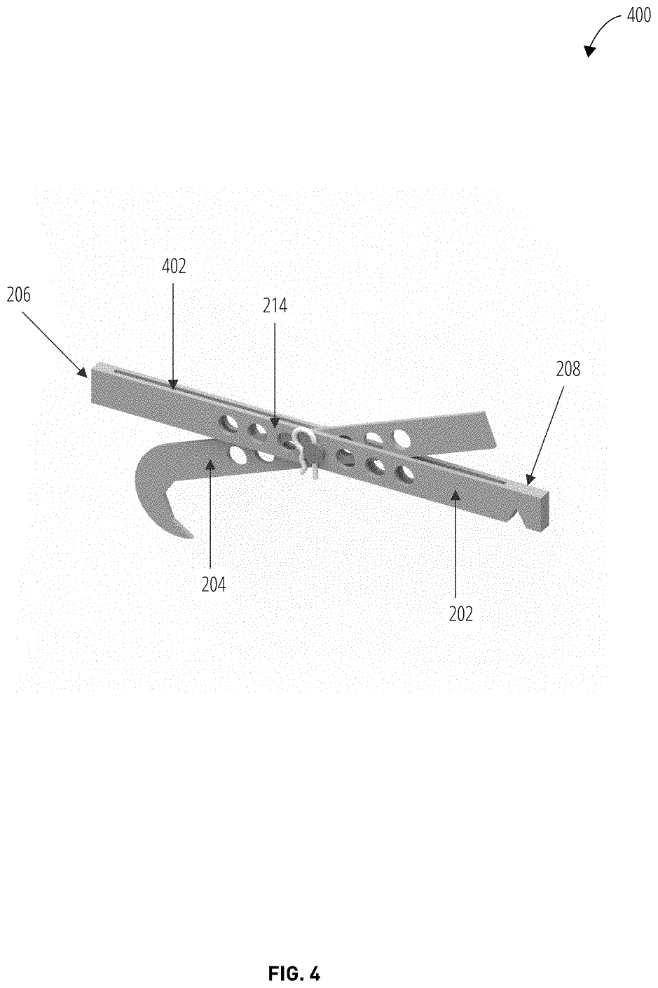

FIG. 4 illustrates the way in which the hooked member 204 of the device may be inserted into shaft of the notched member 214. In this particular embodiment of the invention, a slotted section 402 is fabricated into the notched member 202 that extends from the first end of hooked member 210 to the second end of hooked member 212.

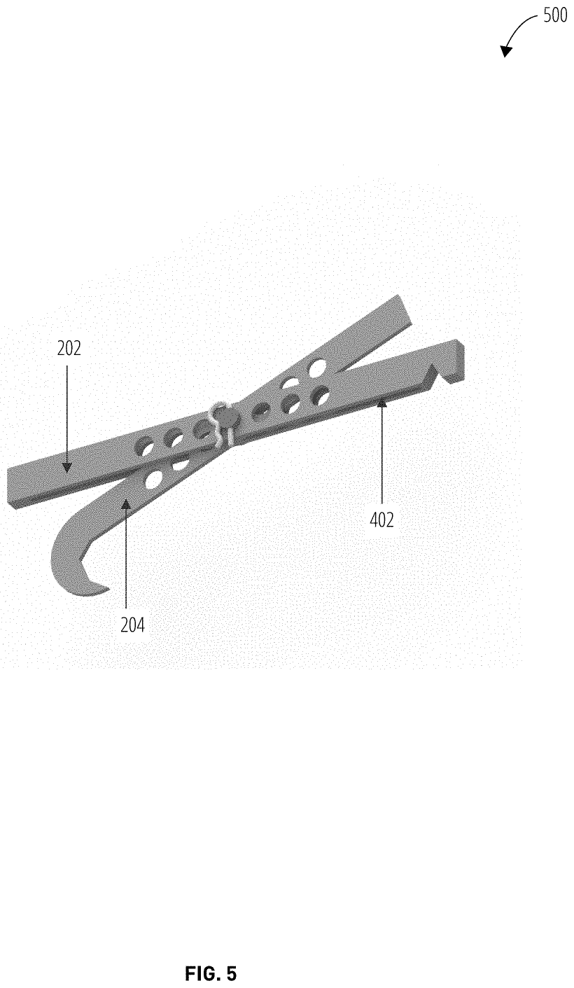

FIG. 5 illustrates a rotated view of FIG. 4. It will be understood by a worker on the field that this particular embodiment, wherein the lever or notched member 202 has a section cut out so the hooked member 204 can pass through, will provides for ultimate strength. This particular orientation also allowed for maximum stability when applying the levering force to the first end of notched member 206.

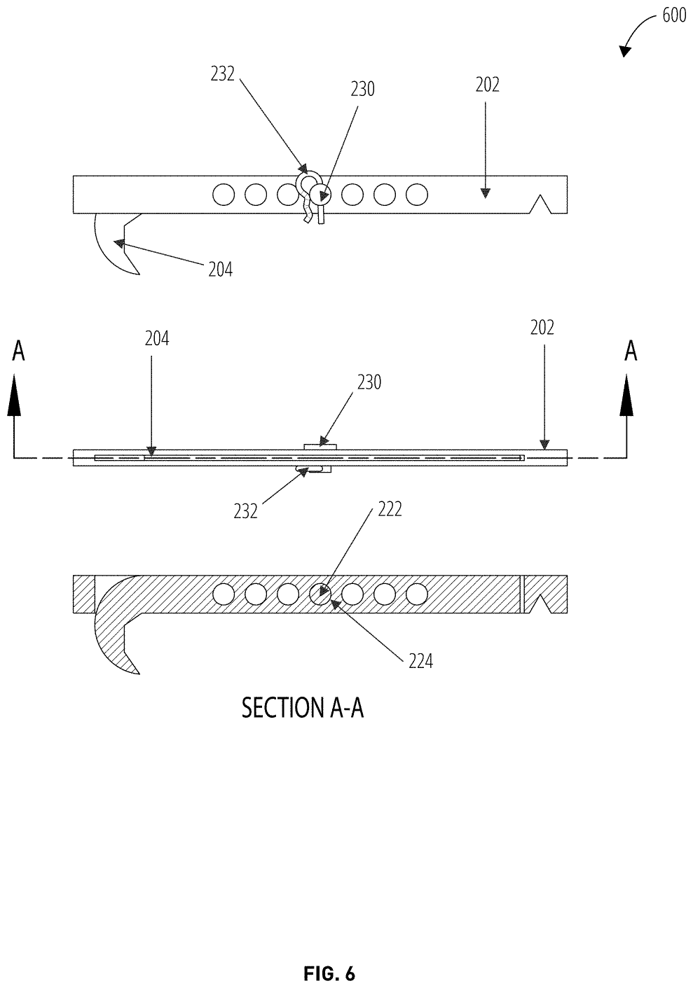

FIG. 6 shows a side view of the device in accordance with an embodiment of the invention. FIG. 6 also shows a cross sectional top-down view of the device.

It can be seen that shaft of the notched member 214 can be sized such that the shaft of hooked member 216 fits completely within the shaft of the notched member 214 for easy storage and transport.

Insertion of a clevis pin 230 into the means of adjustment of notched member 222 and the means of adjustment of hooked member 224 and securing in place by a straight or spring pin 232 prevents the parts from becoming separated or lost during transport.

The foregoing descriptions of specific embodiments of the present invention have been presented for purposes of illustration and description. They are not intended to be exhaustive or to limit the invention and method of use to the precise forms disclosed. Obviously many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

What is claimed is:

1. A device for removing a seal from a spindle wheel axle, said device comprising:
a hooked member having a shaft with a hook at one end, said shaft further having an adjusting means;
a levering member having a first end and a second end, said levering member having a shaft positioned between the first and second ends, said shaft further having an adjusting means;
a connecting means adapted to connect the adjusting means on the hooked member to the adjusting means on the levering member, wherein
when the hook is engaged with the seal, and the second end of the levering member is positioned as a fulcrum on the spindle, a force can be applied to the first end of the levering member to remove the seal.

2. The device of claim 1, wherein the adjusting means on the hooked member and the adjusting means on the levering member are a series of holes bored through the hooked member shaft and the levering member shaft.

3. The device of claim 2, wherein the connecting means is a clevis pin inserted through one of the holes on the hooked member shaft and through one of the holes on the levering member shaft, said clevis pin being secured in place with a cotter pin.

4. The device of claim 1, wherein the second end of the levering member has a notch positioned to engage the spindle at the fulcrum.

5. The device of claim 1, wherein the first end of the levering member is adapted to form a handle.

6. The device of claim 1, wherein the seal is a flange seal.

7. The device of claim 1, wherein the hook is shaped to accommodate different applications.

8. The device of claim 7, wherein the different applications are pulling hubs off trucks or trailers or light duty vehicles; to pull gears off engines or transmissions; or to pull axle seals off automotive or medium duty vehicles.

9. The device of claim 7, wherein the different applications are removal of seals, bearings, sleeves, gears, and caps.

10. A method of using the device of claim 1, for removing a seal from a spindle wheel, said method comprising the steps:
connecting the hooked member to the levering member, via the adjusting means on the hooked member and the adjusting means on the levering member, using the connecting means;
engaging the hook, on the hooked member, with the seal to be removed;
positioning the second end of the levering member on the spindle to form a fulcrum; and
applying a force to the first end of the levering member such that the seal is removed.

11. The method of claim 10, wherein the step of connecting of the hooked member to the levering member by the connecting means comprised the additional step of selecting the appropriate adjusting means on the hooked member and the adjusting means on the levering member, to maximize leverage forces.

12. The method of claim 10, wherein the step of connecting of the hooked member to the levering member by the connecting means comprised the additional step of selecting the appropriate adjusting means on the hooked member and the adjusting means on the levering member, to accommodate spindle wheel of varying sizes.

13. The method of claim 10, wherein the second end of the levering member has a notch positioned to engage the spindle at the fulcrum.

14. The method of claim 10, wherein the first end of the levering member is adapted to form a handle.

15. The method of claim 10, wherein the hook is shaped to accommodate different applications.

16. The method of claim 15, wherein the different applications are removal of seals, bearings, sleeves, gears, and caps.

17. The method of claim 15, wherein the different applications are pulling hubs off trucks or trailers or light duty vehicles; to pull gears off engines or transmissions; or to pull axle seals off automotive or medium duty vehicles.
